(19) United States
(12) Patent Application Publication
(10) Pub. No.: US 2026/0289337 A1
(43) Pub. Date: Sep. 24, 2026

(54) DIFFUSION BASED RETRIEVAL AUGMENTED GENERATION (RAG)

(71) Applicant: THE BANK OF NEW YORK MELLON, New York, NY (US)

(72) Inventors: Vanessa Rose VIDIC, New York, NY (US); Filipe Joao Cabrita CONDESSA, New York, NY (US); Zachariah Eugene TYREE, New York, NY (US); Vadim PERTSOVSKIY, New York, NY (US); Gaurav GUPTA, New York, NY (US)

(21) Appl. No.: 19/532,567

(22) Filed: Feb. 6, 2026

Related U.S. Application Data
(60) Provisional application No. 63/773,708, filed on Mar. 18, 2025.

(51) Int. Cl. G06N 5/022; G06F 16/3329; G06F 18/22; G06F 40/30

(52) U.S. Cl. CPC G06N 5/022; G06F 16/3329; G06F 18/22; G06F 40/30

(57) ABSTRACT

Provided is a system to: access a request comprising input text to search one or more documents; identify chunks of textual information based on the one or more documents; generate a knowledge graph based on the chunks of textual information, wherein the knowledge graph is generated based on contextual relationships between the chunks of textual information; select at least one chunk of textual information based on the input text; select one or more additional chunks of textual information for retrieval-augmented generation (RAG) of in a large language model (LLM), based on diffusion over the knowledge graph from the at least one chunk; and generate a response to the request comprising the input text, by the LLM using RAG based on the selected at least one chunk, the selected one or more additional first chunks and the RAG of the LLM.

### CROSS-REFERENCE TO RELATED APPLICATIONS

This application claims priority to U.S. Provisional Application No. 63/773,708, filed Mar. 18, 2025, the subject matter of which is incorporated herein by reference in entirety.

### TECHNICAL FIELD

The present disclosure relates generally to retrieval augmented generation (RAG) for generative artificial intelligence (AI) models, and more particularly to systems and methods for diffusion-based selection of input data for RAG.

### BACKGROUND

Retrieval augmented generation (RAG) is a technique by which a generative model may be directed to a data set (e.g., a data set not included in a training data set), such as a specific set of input documents, including in addition to other data stored or accessed by a large language model (LLM) or other appropriate model, in order to respond to a query or other input request. In RAG, the relevance of the directed data set may be prioritized over other data, such as data included in the training data, which may increase LLM accuracy, reduce false or spurious output, provide directed searching, update a corpus of knowledge accessible to the LLM, etc. RAG may operate by obtaining (such as by being directed to) directed data (e.g., data not included originally in training data), retrieving, such as by a relevancy search, relevant data from the directed data, and augmenting a query, prompt, or other input request to the LLM in order to return a response. RAG may be especially useful for directed searching of documents provided as directed data and may avoid (or reduce) hallucination problems present in generative artificial intelligence (AI).

### SUMMARY

The following is a non-exhaustive listing of some aspects of the present techniques in accordance with various aspects of the present invention. These and other aspects are described in the following disclosure.

Some aspects include a system, comprising: a processor programmed to: access a request comprising input text to search one or more documents; identify chunks of textual information based on the one or more documents; generate a knowledge graph based on the chunks of textual information; select, from the chunks of textual information, at least one chunk of textual information based on the input text; select, from the chunks of textual information, one or more additional chunks of textual information for retrieval-augmented generation (RAG) in a large language model (LLM), based on diffusion over the knowledge graph from the at least one chunk of textual information; and generate a response to the request comprising the input text, by the LLM suing RAG based on the selected at least one chunk of textual information, the selected one or more additional chunks of textual information.

Some aspects include a non-transitory computer-readable medium storing instructions that, when executed by a processor, programs the processor to: access one or more knowledge graph generated for one or more documents; determine, based on a request comprising input text, a first one or more nodes from the knowledge graph for retrieval-augmented generation (RAG) with a large language model (LLM); select, based on diffusion along the one or more knowledge graph, one or more additional nodes for inclusion in the RAG with the LLM; and generate, based on the first one or more nodes and the selected one or more additional nodes and the LLM, a response to the request.

Some aspects include a method for retrieval-augmented generation (RAG) with a large language model (LLM) comprising: receiving a request comprising input text for the LLM and one or more pieces of input data associated with the request; accessing, for the one or more pieces of input data, one or more knowledge graphs identifying relationships between chunks within the input data, wherein nodes of the one or more knowledge graphs correspond to chunks within the input data; selecting, from the one or more knowledge graphs, at least one node based on the request; selecting, based on diffusion from the at least one node, one or more additional nodes of the knowledge graph; and generating a response to the request, by the LLM using RAG based on the request and the chunks of the input data corresponding to the at least one node and the selected one or more additional nodes.

### BRIEF DESCRIPTION OF THE DRAWINGS

Features, aspects, and embodiments of the present disclosure are described in conjunction with the attached drawings, in which:

FIG. 1 is a schematic diagram depicting an example system for diffusion-based retrieval augmented generation (RAG), in accordance with some embodiments of the present disclosure.

FIG. 2 is a schematic diagram depicting example knowledge graph generation with embedding for diffusion-based RAG, in accordance with some embodiments of the present disclosure.

FIG. 3 is a schematic diagram depicting example knowledge graph generation based on entities for diffusion-based RAG, in accordance with some embodiments of the present disclosure.

FIGS. 4A-4D depict examples of selection of chunks of information for RAG-based response generation based on diffusion, in accordance with some embodiments of the present disclosure.

FIG. 5 is a flowchart illustrating a method for diffusion-based RAG, in accordance with some embodiments of the present disclosure.

FIG. 6 is a flowchart illustrating a method for diffusion-based RAG with embedding of directed data, in accordance with some embodiments of the present disclosure.

FIG. 7 is a flowchart illustrating a method for diffusion-based RAG with entity and relationship triplet extraction from directed data, in accordance with some embodiments of the present disclosure.

FIG. 8 is a schematic of a computing system, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the field of generative AI. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

While some of the embodiments below are described in relation to large language models (LLMs), it should be understood that the systems and methods described herein may apply equally to any generative models, directed searches, foundation models, generative pre-trained transformer (GPT) models, etc. Herein, “external data” and “directed data” may be used interchangeably. As used herein, both “external data” and “directed data” may refer to data to which a trained model is directed (e.g., such as directed for RAG), where that data was not included in the training of the model. The use of the adjective “external” with respect to external data indicates that such data is external to the training data, and does not require that such data be external to the organization (e.g., external to a user, not owned by an organization, data from another organization, etc.) or external in location (e.g., stored in an external server, from an external source, etc.). Likewise, the use of the adjective “directed” with respect to directed data indicates that the model is directed to the data, such as for use in RAG, but does not require a specific direction mechanism (e.g., pointer, user interface direction, etc.) or location. In some embodiments, directed data may include data which was included in a corpus of training data, including data which is re-emphasized to the model or to which the model is specifically directed. In some embodiments. In some embodiments, directed data may contain data which has an unknown inclusion status in the training data—that is, may or may not have been included in the training data for the model. In some embodiments, directed data may contain data which is excluded, including specifically excluded due to ownership (e.g., was not available for model training), age (e.g., was generated after model was trained), etc., from any data used to train the model. As described herein, diffusion may be used to identify components of data, such as directed data, for inclusion in a request, query, or otherwise as model input for any appropriate model, including for a model during training such as for an untrained or partially trained model. Diffusion may be further used to refine or update a model, such as by identifying components of directed data for increased training emphasis. While some of the embodiments below are described in relation to “diffusion”, any appropriate diffusive process may be used—including heat diffusion analogs (e.g., Laplacian diffusion), concentration diffusion (e.g., Navier-Stokes diffusion), diffusive motion (e.g., Markov processes), etc. Diffusion is used herein as a stand in for a diffusive motion (e.g., Markov processes), membrane diffusion (e.g., Frick’s first law of diffusion) etc. Diffusion is used herein as a stand in for any process by which net movement from a region with a higher concentration to regions with lower concentration is described (e.g., quantified or qualified). While diffusion may, in the physical world, describe heat, gas concentration, solute concentration, Brownian motion, etc., or any other gradient-driven movement, “diffusion” as used herein may describe a process by which relevancy is quantified and where relatedness between portions of input data (e.g., directed data) is measured thereby allowing selection, inclusion, ordering, etc. of various portions of information related to an initial request, query, or selection or to subsequently selected portions of information. Diffusion may refer herein to the mathematical process by which relatedness or relevancy is quantified and tracked between pieces of information, where measurements of similarity, relatedness, centrality, etc. may be at least somewhat arbitrary (e.g., may have an arbitrary scale, units, etc.) and may be discrete (e.g., quantized) or continuous.

In order to streamline (e.g., simplify, quicken, lessen the expense, etc.) information retrieval, such as from client, regulatory, or other documents, an entity or employee of an entity may pass data through an information retrieval service or system. These may be as simple as a text search, or as complicated as a generative AI model or more. In some embodiments, a model, such as an LLM, may be used to generate responses to queries. By using RAG with a model, the query may be directed towards a specific document (e.g., one or more pieces of directed data). In some embodiments, RAG may be used, such as with a model, to counter some known deficiencies of generative models. For example, generative models may be prone to hallucinations (e.g., generation of incorrect or nonsensical responses, which may include citation of non-existent material couched as coming from training data), resistant to updating or static in time (e.g., models may be resistant to incorporation of new data generated after training was completed), apt to generate responses based on non-preferred sources (for example, models may present as authoritative answers derived from opinion or biased source material), and likely to confuse terms, especially when similar terms are used differently in different domains. By using RAG, the model may be directed to preferred source material, thereby reducing interpolation that may cause hallucinations, providing current, concrete, and domain-specific data. RAG may increase the speed and decrease the cost of document searching, leading to faster, more-reliable information extraction and increasing an entity’s ability to make decisions based on such document searching. Conversely, inaccurate document searching and querying (e.g., generation of responses by generative models) may lead to costly mistakes for an employee or entity where decisions are based on erroneous information. Improvement in RAG ability may therefore improve the value of generative models with RAG.

In some embodiments, RAG may operate, with a generative model, by providing for the identification of directed data together with an input request (e.g., query). The directed data need not be input simultaneously with the input request—in some embodiments, the directed data may be identified before, after, concurrently, etc. with the input request. Once the input request and directed data are identified, various pieces (e.g., chunks of information) from the directed data may be identified as relevant to the input request. The methods of identifying relevant material in the directed data may include semantic similarity, and may not identify the most relevant information from the directed data, especially if different (e.g., non-identical) terms are used for material that is actually similar or relevant. Semantic similarity may also ignore connections, linkages, relatedness, etc. between portions of directed data which use non-identical terms, even if the subject matter is similar. That is, the usefulness of RAG in overcoming generative model limitations may itself be limited by the accuracy and efficiency of the relevancy search through the directed data. Therefore, by improving the relevancy search through the directed data, such as by the use of diffusion-based RAG, RAG itself may be improved. Once relevant sections of the directed data are identified, these may be added (e.g., appended) to the input request and processed by the generative model to generate a response (e.g., answer to the query). The addition of the relevant sections of the directed data to the input request may cause the LLM or other model to focus on extracting answers from data pre-identified as relevant to the input request and preferentially selected by the user.

In some embodiments, RAG with an LLM may be improved by improvement of extraction of information from the directed data by the use of diffusion (or a diffusion analog), such as by application of one or more diffusion equation, to identify relevant and related material from the directed data. The use of diffusion may rely on identifying of chunks of information within the directed data and assignment of values (e.g., to which the diffusion equation may be applied) to those chunks. Various methods of value assignment may be used, as well as various different diffusion methods and equations.

The relatedness of various portions of directed data may be represented by connections in a knowledge graph, or any other appropriate map of relatedness. The knowledge graph need not be a physical representation (e.g., drawing) of the relatedness, but may instead be represented purely mathematically, such as in a vector notation containing values linking various portions of the directed data. Herein, any use of “knowledge graph” should be taken to account for both pictorial and mathematical depictions of relatedness between information. Knowledge graphs, in general, may map relationships between data, entities, etc., such as by representing objects as nodes and the relationships between such objects as edges. The use of knowledge graphs herein is illustrative, such as to provide ease of description of relatedness and depiction of diffusion flow between nodes. However, any other appropriate mapping of relatedness may be used instead, such as the aforementioned vector notation. Any appropriate knowledge graph may be used to map relatedness, such as a substantially fully connected knowledge graph, a partially connected graph, a sparsely connected graph, multiple sub-graphs, etc. The shape and form of the knowledge graph may be based on the form and relatedness of the data represented by the knowledge graph. The knowledge graph may be unrelated to the values and architecture of the generative model or LLM for which RAG is applied. That is, the knowledge graph may be formed independently of the model, such as based only on the directed data. Although the generative model may itself have nodes and connections (e.g., between layers of a neural network (NN) or other model architecture), these nodes and connections and values thereof may be independent of the knowledge graphs discussed herein.

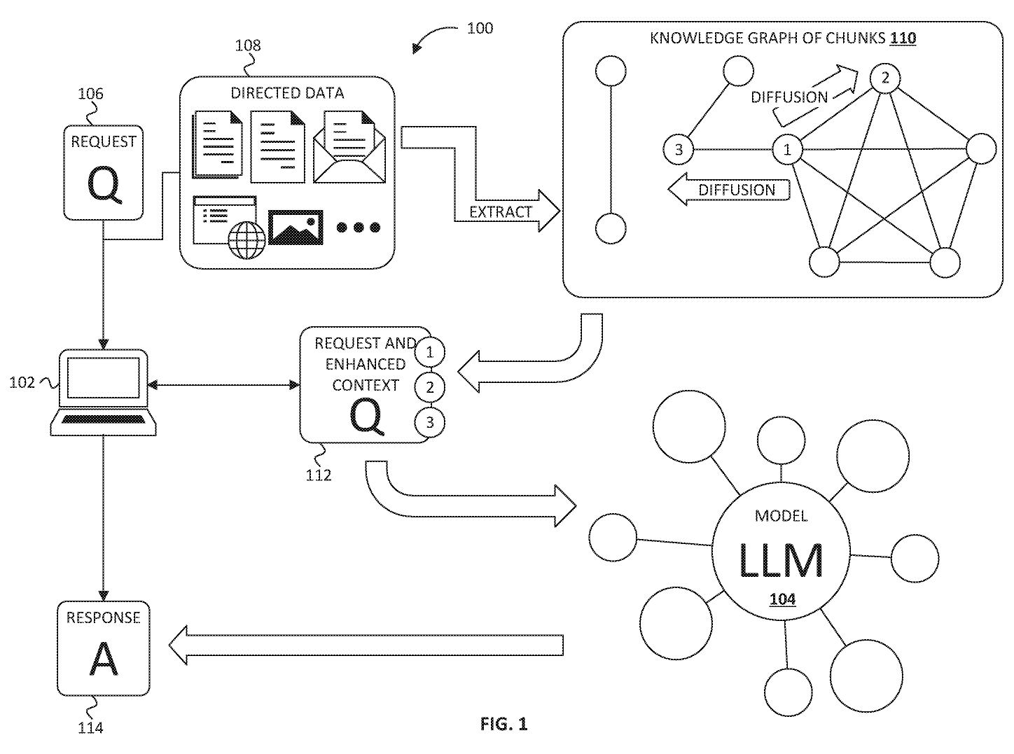

FIG. 1 is a schematic diagram depicting an example system 100 for diffusion-based RAG. The system 100 may operate on a computing device 102, which may be any appropriate computing device, such as a laptop, smartphone, mainframe, etc. and which may be in communication with any appropriate internal or external network, processor, memory, storage, etc. The computing device 102 may be a distributed computing device. The computing device may store or be in communication with a generative model, such as LLM model 104. As previously described, the LLM model 104 may instead or additionally be any appropriate generative model, including an ensemble model. The LLM model 104 may be stored in any appropriate location, such as in a cloud, on a remote server, on the computing device 102, etc. The LLM model 104 may be of any appropriate size, architecture, value, etc., including a truncated model, a student model from a student-teacher model pair, a partially trained model, a foundation model, etc. The computing device 102 may receive as input a request 106. The request 106 may be any appropriate request for the LLM model 104. The request 106 may be a query. The request 106 may be or include a prompt. The request 106 may be supplied to any appropriate input container, including in a webpage or other interface for the LLM model 104. The computing device 102 may provide a customized interface for the LLM model 104 or any other appropriate interface for a user to access the LLM model 104, including a webpage or text box which is not customized for the specific LLM model 104, or for the use of RAG, or for diffusion-based RAG.

In some embodiments, the request 106 may be supplied with one or more pieces of directed data 108. The directed data 108 may be supplied concurrently with, before, or after the request 106. In some embodiments, the directed data 108 may be identified to the LLM model 104 through the same interface used to submit the request 106, such as by a drag-and-drop action, a search of storage or memory associated with the computing device 102, or by input into any appropriate input container. In some embodiments, the directed data 108 or an application that displays the directed data 108 may call the LLM model 104 and accept the request 106, such as through a macro or other command. The directed data 108 may be supplied as part of a prompt or other alternative or additional input supplied with the request 106.

The directed data 108 may be any appropriate directed data, such as one or more word processing document, database, email, webpage, image file, portable document file (PDF), etc. The directed data 108 may be textual data—that is, may be in text or alphanumerical (including numerical) format. The directed data 108 may be image data—that is, may contain images of text or other object but may not have associated ASCII values. In some embodiments, textual but not readable directed data 108 may be converted to readable textual data, such as by optical character recognition (OCR). In some embodiments, the directed data 108 may be pictorial data—that is image data which does not contain text. In some embodiments, non-textual directed data 108 may be converted to textual data, such as by use of a computer vision model to describe the objects in a pictorial image. In some embodiments, the directed data 108 may include both textual and non-textual information. The directed data 108 may be subject to any appropriate pre-processing, such as grammatical correction, image recognition, deskew, duplicate removal, etc., which may be image, textual, or any other appropriate type of data correction or cleaning.

From the directed data 108, multiple “chunks” of information may be extracted. As used herein, the term “chunk” refers to a portion of the directed data 108. A chunk may be of any appropriate size. For example, a chunk may be a word, a paragraph, a sentence, multiple sentences, a page, and even, in some cases, an entire document. In some embodiments, a chunk may be a character or fewer characters than a word. The chunks into which a piece of directed data 108 is divided may have any appropriate chunk overlap, ranging between substantial overlap to no overlap. A chunk may be determined by any appropriate method, including by a recursive text splitter. The chunks into which a piece of directed data 108 are divided may be stored, including together with the piece of directed data 108.

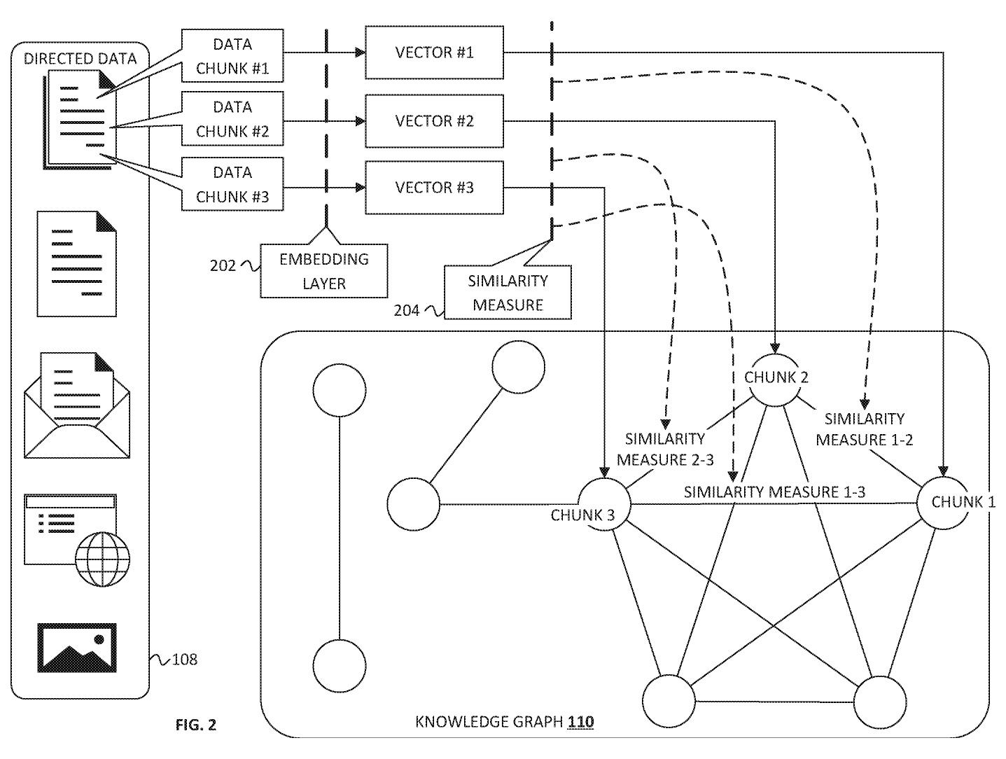

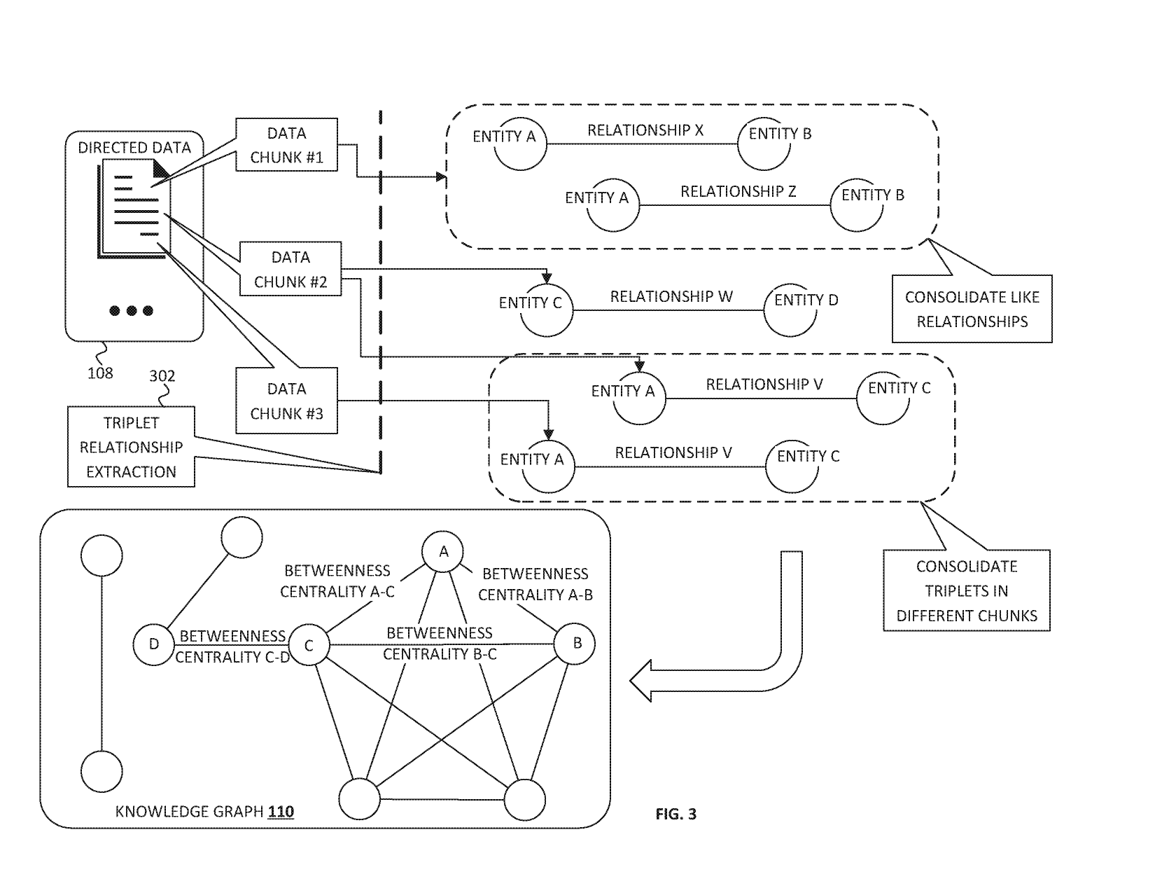

From the chunks of directed data 108, a knowledge graph 110 may be constructed. The knowledge graph 110 may be any appropriate knowledge graph, as previously described. The knowledge graph may be a set of knowledge graphs. In some embodiments, such as the knowledge graph with embedding which will be described in relation to FIG. 2, the knowledge graph 110 may be a fully connected knowledge graph. In other embodiments, such as the knowledge graph with entity identification which will be described in relation to FIG. 3, the knowledge graph 110 may be substantially less than fully connected. The architecture of the knowledge graph 110 may depend on the relationships identified between the chunks of the directed data 108.

Based on the request 106, a first chunk of information may be identified as most relevant—e.g., most relevant to the request 106, a prompt which may be part of the request 106 or in addition to it, or to any other appropriate input to the computing device 102 or the LLM model 104. In some embodiments, the first chunk of information may be multiple first chunks of information. For example, if the knowledge graph 110 is made up of two separate (e.g., not mutually connected) sub-graphs, a first chunk of information may be selected, such as based on the request 106, in each of the sub-graphs. In another example, multiple chunks of information may be selected as the first chunk of information, including from the same knowledge graph 110 or sub-graph of the knowledge graph 110, if their relevancy score is the same, including the same to within a threshold. The first chunk of information may be identified as most relevant by any appropriate means, such as by a similarity calculation (e.g., cosine similarity, Euclidean distance, dot product, etc.), semantic similarity score, similarity score of an embedding or other representation of the chunks of information with the request 106, etc. to the request 106. Herein, any similarity calculation for an embedding or other vector-containing object may be a cosine similarity calculation or any other appropriate similarity measure, including a flattened (e.g., non-vector) similarity measure). In some embodiments, the first chunk of information may be identified as most relevant when compared to the relevancy scores of substantially all other chunks of information, such as by determining a maximum relevancy score, ordering the relevancy scores, etc. In some embodiments, the relevancy scores between the request 106 (or another input) and the chunks of information may be relative scores. In some embodiments, the relevancy scores between the request 106 (or another input) and the chunks of information may be absolute scores, for example scores which have a set value range, and which may identify as first chunks of information any chunk of information with a relevancy score above a threshold. In some embodiments, the relevancy score may be based on a vector representation, such as an embedding, of the chunk of information. In some embodiments, the relevancy score may be based on a comparison between two (or more) vector representations, such as a vector representation of the request 106 (or any other appropriate input such as a prompt) and a vector representation of the given chunk of information. In some embodiments, the relevancy score may be a cosine similarity calculation or any other appropriate similarity determination, based on one or more embedding, including those described previously. In some embodiments, the relevancy score may be based on a cosine similarity calculation (or other appropriate similarity calculation) without embedding.

From the first chunk of information, one or more additional chunks of information may be selected for RAG, based on diffusion. Any appropriate diffusion equation, such as a Laplacian heat diffusion equation or any of the other diffusion equations previously described, may be used to determine the additional one or more chunks of information. In some embodiments, the one or more additional chunks of information may be selected by setting a heat or other value (or analog thereof) for the first chunk of information and determining, such as over time, where the heat or other value or analog thereof travels by diffusion, such as over the knowledge graph 110. In some embodiments, the first chunk of information may be taken to have a heat value of 1, while all other chunks of information may be taken to have a heat value of zero, such as at a time zero. Then, based on diffusion of heat (or another analog) from the first chunk of information over time, the heat value of the other chunks of information may be determined at a second time. The diffusion rate between the various chunks of information may be determined by relatedness values determined between each of the chunks of information. In some embodiments, the relatedness values may be similarity values, between the various chunks of information. In some embodiments, the relatedness values may be similarity values determined between embeddings or other vector representations of the various chunks of information. In some embodiments, the relatedness values may be edge weights, for edges between various nodes. Edge weights may be any appropriate edge weights, examples of which will be discussed in more detail as follows. In some embodiments, the relatedness values may be betweenness centrality or other edge importance values.

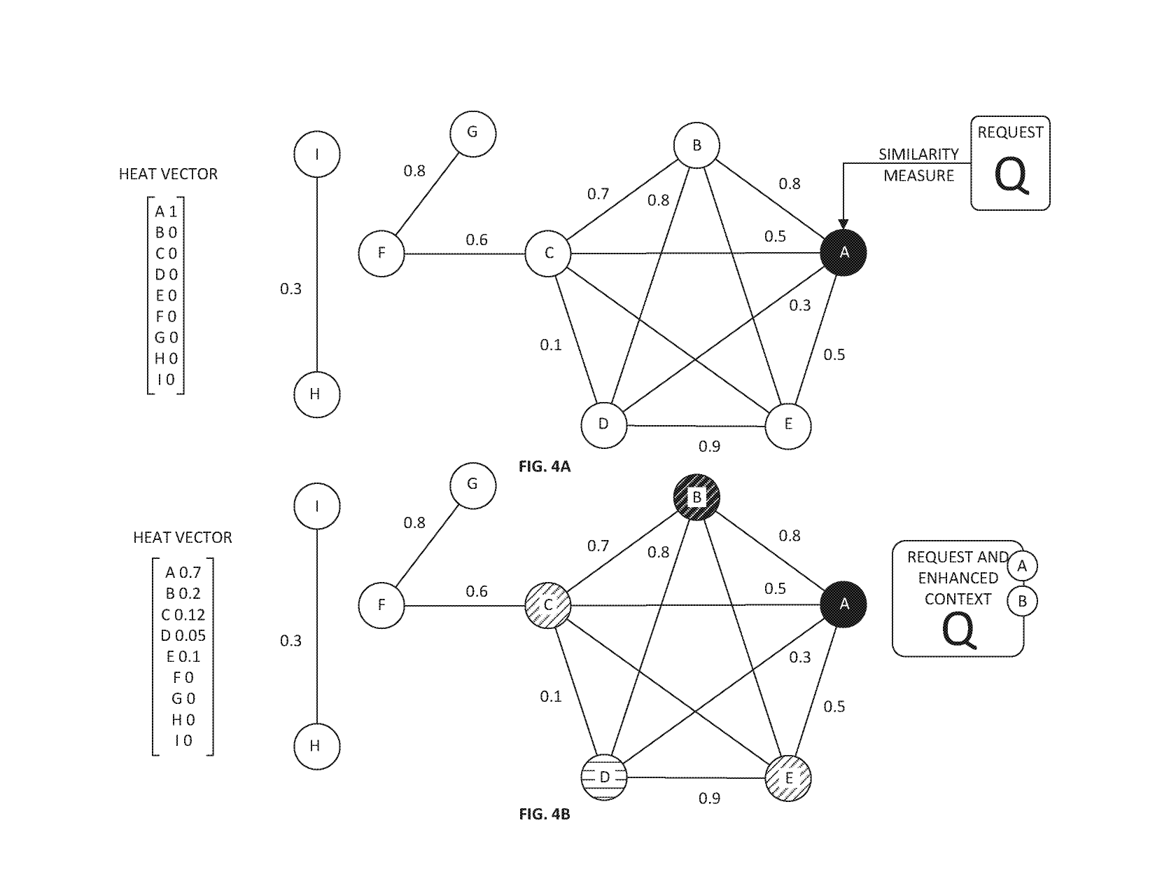

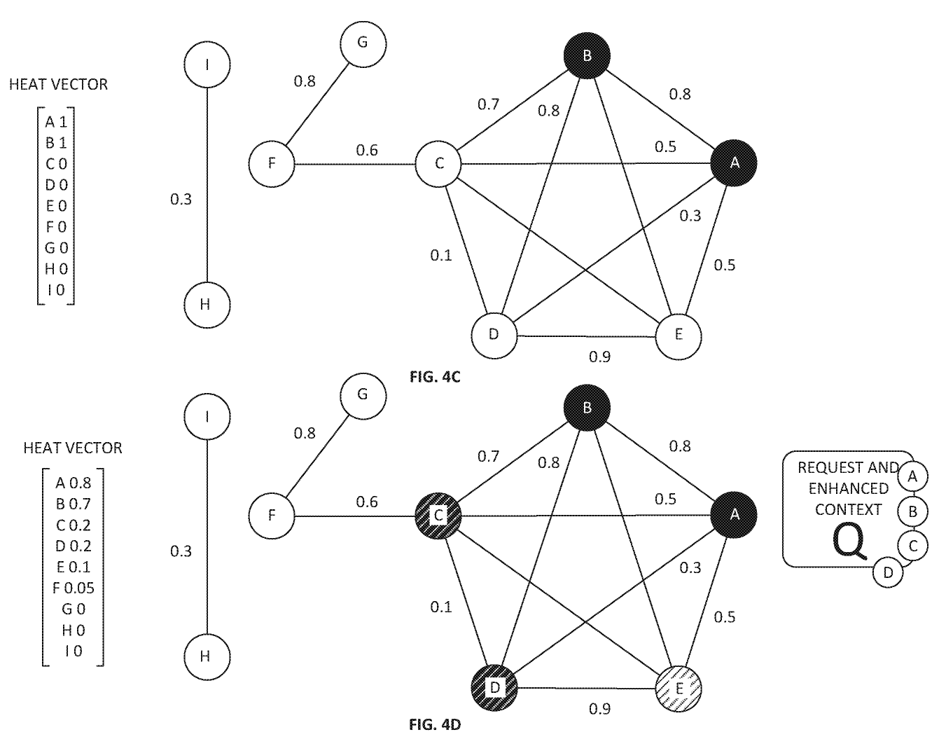

Additional chunks of information may be chosen, such as iteratively, until a termination criterion is reached. The termination criterion may be a size of a knowledge window, such that additional chunks of information are selected until the knowledge window is filled. The termination criterion may be a time or number of iterations of diffusion. The termination criterion may be a distance traveled (e.g., along the knowledge graph) from an initial node (e.g., corresponding to the first chunk of information). The termination criterion may be any appropriate termination criterion. In some embodiments, a time-evolving diffusion may be performed, until the termination criterion is reached (as will be described in relation to FIG. 4B). In some embodiments, multiple time-evolving diffusions may be performed, such as with different starting parameters (e.g., different selected first chunks of information), until the termination criterion is reached (as will be described in relation to FIGS. 4C-4D). Additional chunks of information may be selected from any appropriate part of the knowledge graph. That is, the one or more additional chunks of information may be non-adjacent on the knowledge graph.

Once the termination criterion is satisfied, the selected chunks of information may be joined (e.g., appended) to the request 106 to generate an enhanced request 112. The enhanced request 112 may be made up of the selected chunks of information (e.g., the first chunk of information, the one or more additional chunks of information, and any other selected chunks of information) and the request 106. The enhanced request 112 may then be supplied, such as by the computing device 102, to the LLM model 104. Based on the enhanced request 112, the LLM model 104 may supply a response 114, which may be the diffusion-based RAG response 114 to the request 106.

The creation of the knowledge graph and which parts of the directed data correspond to the nodes and are used to determine edge values may differ among different embodiments. Two different types of knowledge graphs are described in further detail hereafter. It should be noted that the methods described may be used in combination or in alternative, including in partial combination. Each of these methods may be used with any appropriate directed data, chunking protocol, data cleaning, generative model, knowledge window, etc. The system 100 of FIG. 1 may be used with either the method and knowledge graph of FIGS. 2 or 3 or a combination thereof.

FIG. 2 is a schematic diagram depicting example knowledge graph generation with embedding for diffusion-based RAG. In RAG with embedding, the directed data 108 may be any appropriate directed data, such as that described in relation to FIG. 1. The directed data 108 may be divided into chunks of information, by any appropriate method, such as those described in relation to FIG. 1. In FIG. 2, a piece of directed data 108 is depicted as divided into three (3) data chunks, data chunk #1, data chunk #2, and data chunk #3. These chunks are illustrative only, and each piece of directed data 108 may be divided into more or fewer chunks. Once the data chunks are extracted from the directed data 108, they are then embedded or otherwise converted into a vector representation. The data chunks may be passed through an embedding layer 202. In some embodiments, the embedding layer 202 may be the embedding layer of the generative model used for RAG (e.g., the LLM model 104 of FIG. 1). The embedding layer 202 may generate vectors, e.g., vector #1, vector #2, and vector #3 for data chunk #1, data chunk #2, and data chunk #3, respectively. The vector may have any appropriate size, dimension, value, vector space, etc. Similarity measures between each of the vectors may then be determined, such as by a similarity measure 204. The similarity measure may be any appropriate similarity value, such as a cosine similarity calculation or any other similarity value previously described or any composition of a similarity measure with any other appropriate function, such as a non-decreasing function or other relative similarity preserving function. The similarity measures may be determined between each pair of vectors, corresponding to each pair of data chunks. In some embodiments, vectors corresponding to the chunks of information (and the request 106) may be data representations other than embeddings, including embeddings from a different model (e.g., a model other than the LLM model 104 of FIG. 1) than the model used for RAG. In some embodiments, the similarity measure may be or include a similarity measure not based on an embedding. For example, the similarity measure may include a similarity measure which corresponding to a relative document location (e.g., where chunks of information which are close to each other in the directed data have a higher document location similarity than chunks of information which are further apart), instead or of in addition to a cosine similarity based on embeddings. Multiple similarity measures may be combined, such as by any appropriate weighting or relative value preserving function. Based on the similarity measures, the knowledge graph 110 may be constructed.

The knowledge graph 110 may contain nodes, where each node represents a data chunk—such as a data chunk from at least one piece of directed data 108. The edges of the knowledge graph 110 (e.g., the connections between the nodes, depicted in FIG. 2 as connection lines) may have numerical values corresponding to the strength of relatedness between each of the chunks of information, as represented by the nodes. In some embodiments, the knowledge graph 110 may be a fully connected knowledge graph, where each node is connected by at least one edge to each other node. In some embodiments, the knowledge graph 110 may be less than fully connected. For example, for edges with values (e.g., strength of relatedness, similarity measures, or any other appropriate edge weights.) below a threshold (or equal to zero), the edges may be removed. In another example, these edges may remain, even if they have values substantially equal to zero or otherwise negligible for diffusion determination. The values of the edges of the knowledge graph may be determined by any appropriate method. The placement (e.g., location) of the nodes in the knowledge graph may be determined by any appropriate method. For example, the nodes may be placed based on the order of the chunks of information in the directed data 108 (e.g., as depicted in FIG. 2). In another example, the nodes may be placed based on an order of relatedness, such that the most connected nodes are closest together.

As depicted in FIG. 2, the nodes may be placed on vertices of the knowledge graph 110. Each node may correspond to substantially one chunk of information from the directed data 108. Nodes may store metadata corresponding to each chunk of information, such as its location in the directed data 108, chunk identifier, document identifier, etc. Each node may be connected to at least one other node by an edge, where the edge may have a value which corresponds to a similarity measure determined for the nodes it connects. In some embodiments, one or more nodes may be disconnected (e.g., not connected by an edge) from others of the nodes. In some embodiments, fully disconnected nodes may be ignored for diffusion-based RAG, as no diffusion may occur to or from such nodes.

Diffusion may occur along the knowledge graph 110 (e.g., along the edges of the mesh connecting the nodes) based on any appropriate diffusion equation or regime. Diffusion may occur as previously described. Iterative diffusion will also be described in further detail in relation to FIGS. 4A-4D. Diffusion may be used to select relevant chunks of information for RAG.

In some embodiments, diffusion may start with a first chunk of information selected based on the embedding layer 202 and the similarity measure 204. For example, a request (e.g., the request 106 of FIG. 1) to the generative model (e.g., the LLM model 104 of FIG. 1) may be turned into a vector representation, such as by passing it through the embedding layer 202. The first chunk of information may then be identified by determining the node of the knowledge graph 110 with the greatest similarity to the request, such as by determining similarity measures between the embedding of the request and the embeddings of the chunks of information from the directed data 108. The first chunk of information may be selected by any appropriate method, such as those described in relation to FIG. 1.

FIG. 3 is a schematic diagram depicting example knowledge graph generation based on entities for diffusion-based RAG. In RAG with entity identification, the directed data 108 may be any appropriate directed data, such as that described in relation to FIG. 1. The directed data 108 may be divided into chunks of information, by any appropriate method, such as those described in relation to FIG. 1. In FIG. 3, a piece of directed data 108 is depicted as divided into three (3) data chunks, data chunk #1, data chunk #2, and data chunk #3 (which may be the same or different chunks than depicted in FIG. 2). These chunks are illustrative only, and each piece of directed data 108 may be divided into more or fewer chunks. Once the data chunks are extracted from the directed data 108, various entities and relationships between entities may be identified within the chunks. For example, each chunk of information may be passed through a relationship extractor 302. The relationship extractor 302 may by an LLM or another appropriate model with identifies entities (e.g., nouns, proper nouns, objects, companies, organizations, concepts, terminologies, etc.) described in the chunks of information. The relationship extractor 302 may identify the relationships (e.g., verbs, adverbs, actions, etc.) which occur between entities, by entities, on entities, etc. In some embodiments, the relationship extractor 302 may be a triplet relationship extractor which may identify entities and the relationships between such entities (e.g., between different entities). In some embodiments, the relationship extractor 302 may also identify recursive relationships (e.g., relationships between an entity and itself). The relationship extractor 302 may operate as a single stage to generate triplet relationship, or as a multi-stage process, such as to identify entities and then identify relationships between entities.

As depicted in FIG. 3, the relationship extractor 302 may identify multiple relationships between the same or different entities. For example, the relationship extractor 302 may identify a first relationship X between entity A and entity B and a second relationship Z between entity A and entity B. In another example, the relationship extractor 302 may identify a relationship V between an entity A and an entity C in multiple chunks of information (e.g., in data chunk #2 and data chunk #3). In some embodiments, once extracted, the relationships may undergo a data cleaning and consolidation process. For example, like relationships may be consolidated, such that one edge which represents multiple relationships (e.g., relation X and relations Z for entities A and B) may run between entities which have multiple relationships with one another. In another example, relationship triplets which occur in multiple chunks of information may be consolidate, while information identifying the chunks of information in which they are found may be maintained. In some embodiments, the relationship triplets may be condensed, e.g., to remove duplicate instances of the same relationship triple, to a set of unique relationship triplets present in the directed data 108.

In some embodiments, nodes of the knowledge graph 110 may correspond to entities of the extracted relationships. The nodes may further contain metadata corresponding to each chunk of information, such as its location in the directed data 108, chunk identifier, document identifier, etc., which contains the entity. While in the method depicted in FIG. 2, each node may represent a chunk of information directly, in the method depicted in FIG. 3 each node may represent an entity which then corresponds to one or more chunk of information of the directed data 108.

The knowledge graph 110 may be constructed of the nodes corresponding to the entities of the extracted relationships, where the edges between nodes may correspond to one or more relationships. In some embodiments, the knowledge graph 110 may be less than full connected. That is, entities which have no relationship with one another in the directed data 108 may have no connecting edges. In some embodiments, the knowledge graph 110 may be fully connected, where entities which have no relationship with one another in the directed data 108 may have a connecting edge, which may, for example, be given a null value. The placement (e.g., location) of the nodes in the knowledge graph 110 may be determined by any appropriate method. For example, the nodes may be placed relative to one another based on whether or not they occur in any relationship triplet with one another. Nodes which are placed closer together may have triplet relationships, while nodes which are spaced more distantly may not have triplet relationships or may have relatively fewer triplet relationships with distant nodes.

In another example, the nodes may be placed based on a strength of relatedness, such that the most connected nodes are closest together, where most connected may be determined by a measure of relatedness, or a measure of relationship strength. In some embodiments, relationship strength may be determined by a model, ranking, etc., such that relationships which include stronger words are determined to be stronger. For example, if relationship X is “owns” and relationship V is “partners with”, the relationship between entity A and entity B (where entity A owns entity B) may be determined to be stronger than the relationship between entity A and entity C (where entity A partners with entity C). Any appropriate method of node placement may be used.

The edges between the nodes (e.g., the entities) may have no value during an initial construction of the knowledge graph 110. That is, the knowledge graph 110 may be unweighted and undirected once the nodes are placed. Edge values (e.g., edge weights) may be determined by any appropriate method, such as by a measure of similarity as previously described in relation to FIG. 2 (or any other appropriate measure of similarity) or based on a relationship strength as described above. In some embodiments, in order to determine values for the edges of the knowledge graph, betweenness centrality may be used. To determine betweenness centrality, for each node a shortest path may be determined to each other node in the knowledge graph 110. In some embodiments, path determination may be more straightforward for a less than fully connected knowledge graph. In other embodiments, null segments in a fully connected knowledge graph may be considered to be disallowed paths. Based on the shortest path length between each of the nodes, a given node may be assigned a value relative to how many times it is passed (e.g., traversed) by the set of shortest paths. This value may indicate how central a given node is to the relationship network contained within the directed data 108. Each edge may then be given a value which corresponds to the sum (or average or other appropriate quantity) of the nodes it connects. In some embodiments, edge values may also or instead correspond to document location, such as where edges between nodes which correspond to chunks of information which are located close to one another in the document may be larger than edge values for nodes which are located distant from one another. In some embodiments, the values of the edges may then be normalized, such that the greatest edge value is 1 and the smallest edge value is 0 (or any other appropriate range).

Diffusion may then occur along the knowledge graph 110 (e.g., along the edges connecting the nodes) based on any appropriate diffusion equation or regime. Diffusion may occur as previously described. Iterative diffusion will also be described in further detail in relation to FIGS. 4A-4D. Diffusion may be used to select relevant chunks of information for RAG, such as by selection of nodes and then selection of the chunks of information corresponding to such selected nodes.

In some embodiments, diffusion may start with a first chunk of information or first entity or even a first relationship. An entity, node, triplet relationship, chunk of information, etc. may be selected based on any appropriate method, such as based on a similarity measure between a request (e.g., the request 106 of FIG. 1) and the entities, nodes, triplet relationships, chunks of information, etc. of the directed data 108. For example, a request 106 may contain an entity D, where the entity D may then be selected as the node and where the chunks of information which contain entity D may be selected as the first chunk of information or chunks of information. In another example, a request 106 may be used to determine a most relevant chunk of information, such as based on a cosine similarity calculation, and the most relevant chunk of information may be selected as the first chunk of information and all nodes corresponding to the first chunk of information (such as by corresponding metadata) may be selected as “heated” nodes for diffusion. The first chunk of information may be selected by any appropriate method, such as those described in relation to FIGS. 1 or 2.

In some embodiments, multiple knowledge graphs may be used with diffusion, including knowledge graphs which may have the same or different nodes, connectedness, edge weights, etc. For example, a knowledge graph generated based on embeddings (such as depicted in FIG. 2) may be used in conjunction with a knowledge graph generated based on triplet relationships (such as depicted in FIG. 3). The multiple knowledge graphs may be used sequentially, alternately, concurrently, etc. For example, a first diffusion may be performed on a first knowledge graph and a second diffusion may be performed on a second knowledge graph, where the selected chunks of information determined by the first diffusion and the second diffusion may both be used for RAG, where the second diffusion may include the same or different chunks that identified by the first diffusion. In another example, the chunks of information may be weighted by where they are selected in the first diffusion (e.g., in the order of chunks of information selected in the first diffusion) and by where they are selected in the second diffusion (e.g., in the order of chunks of information selected in the second diffusion, such as to generate a weighted order of selection by which they may be selected for inclusion in RAG.

In some embodiments, multiple types of edge weights may be used with diffusion, including with the same or different knowledge graphs. For example, for multiple knowledge graphs with the same nodes, different multiple weights may be determined such as by different methods, such as by cosine similarity of embeddings, betweenness centrality, etc. If the nodes of the multiple knowledge graphs are the same, these edge weights may be combined, in some embodiments, such as by a weighted combination or any other appropriate linear or relative strength preserving combination, to generate combined edge weights. The multiple knowledge graphs may then be combined into a single knowledge graph with the combined edge weights, which may be used for diffusion to select chunks of information for RAG. For multiple knowledge graphs with different nodes or, in some cases, different connectedness, edge weights and node arrangements from multiple knowledge graphs may be combined to generate a single knowledge graph with multiple sub-graphs or sub-nodes. For example, a node corresponding to a first chunk of information may contain sub-nodes corresponding to a first entity and a second entity found within the first chunk of information, where each node and sub-node may be connected to various other nodes and sub-nodes by edges with edge weights. Any appropriate knowledge graph architecture may be sued to combined multiple knowledge graphs with different nodes and multiple edge weight determination methods. Any appropriate edge weight determination may be used, including any appropriate combination of those methods previously discussed.

FIGS. 4A-4D depict examples of selection of chunks of information for RAG-based response generation based on diffusion. FIGS. 4A-4D depict example knowledge graphs, which are less than fully connected. In some embodiments, the knowledge graphs may instead be fully connected. FIGS. 4A-4D depict heat vectors which describe the state of “heating” of the various nodes of the knowledge graphs at given “times” in diffusion. Both the state of “heating” and the concept of time-evolution of diffusion of such heat are conceptual rather than representative of physical phenomena. In FIGS. 4A-4D, the relative heat of each node is represented by color, with darker nodes corresponding to “hotter” nodes as described by the heat vector. As previously described, the knowledge graph itself is an illustrative concept used here for ease of depiction, but diffusion may be described instead entirely in matrix notation.

FIG. 4A depicts an initial state of heating for a knowledge graph. In the initial state, a first chunk of information (per the method described in relation to FIG. 2) or a first node corresponding to a first chunk of information (per the method described in relation to FIG. 3) is heated. The node which is selected for heating (e.g., node A as depicted in FIG. 4A) may be selected by any appropriate method, such as by virtue of a similarity measure value when compared with an input request (such as the input request 106 of FIG. 1). The heating may be described by a heat vector, in which the value of the heat vector corresponding to node A is held at 1 while all other values of the heat vector (for all other nodes) are 0. The heat vector may be normalized. In some embodiments, the heat vector may not be normalized or the heat vector values may not be between zero and one—for example they may be between zero and one hundred, between two and five, between negative one and one, unbounded, etc. Because the heat applied is a concept, not a physical representation of temperature (e.g., energy), normalization may not be performed in some embodiments.

One or more diffusion equation may then be performed on the knowledge graph, where the heat distribution may evolve over time based on the values of the connections (e.g., edge values) between the nodes. Diffusion may describe how each node gain and loses heat based on the heat of its neighbors and the ease with which heat transfers between (nearest) neighbors. The time evolution of the diffusion may be adjusted by one or more proportionality factor, such that for a first time (as depicted in FIG. 4B) greater than zero some heat has diffused from the first selected node (e.g., chunk of information) but the heat of the nodes is still sufficiently non-equalized to allow for selection of one or more additional node or chunk of information for RAG.

FIG. 4B depicts a state of heating for the knowledge graph of FIG. 4A at a time greater than zero. As time is arbitrary, this time may be any appropriate time that allows for selection of additional nodes for inclusion in RAG. For example, this time may be 0.0001, 0.001, 0.01, 0.1, 1, 10, 100, 1,000, etc. The time may or may not have units. That is, based on the diffusion equation chosen, the time may be dimensionless or may have units of seconds or any other appropriate units. As the heat applied on node A in FIG. 4A diffuses, the connected nodes heat up, but may heat up relative to their relatedness (e.g., measure of similarity, betweenness centrality, etc.) to the hot node. For example, node B heats up more (or more quickly) than other nodes connected to node A, due to having the higher value of relatedness (e.g., 0.8) than the other nodes (e.g., 0.5 for node C, 0.3 for node D, and 0.5 for node E). The heating of node B is further reflected in the values of the heat vector of FIG. 4B. Based on the state of the heat present in the knowledge graph, node B may be selected for inclusion in RAG, such as with the enhanced request 112 of FIG. 1. Node B may correspond to a chunk of information (e.g., as described in the method depicted in FIG. 2) or an entity which may correspond to one or more chunk of information (e.g., as described in the method depicted in FIG. 3). If the inclusion of node B in the enhanced request satisfies the knowledge window, diffusion may end and RAG may be performed with the enhanced request. If the inclusion of node B in the enhanced request does not satisfy the knowledge window (or other termination criterion), diffusion may continue. In some embodiments, diffusion may continue along the same time path depicted in FIG. 4B as a continuation of the diffusion which has already occurred. For example, further diffusion may lead to the inclusion of node C, then node E, with nodes I and H never included in the enhanced request for RAG. Alternatively, a different time evolution of diffusion may be used, as depicted in FIG. 4C, in which a different initial heat vector is applied to the knowledge graph.

FIG. 4C depicts an iteration of diffusion subsequent to that depicted in FIG. 4B. In some embodiments, once a node is selected for inclusion in an enhanced request, additional nodes may be selected by restarting a time-evolving diffusion process. As node B was previously selected in relation to FIG. 4C, the diffusion process may be restarted with both node A and node B “heated” (e.g., as an initial state). The heating may be described by the heat vector, in which, as depicted in the example shown in FIG. 4C, the values of the heat vector corresponding to node A and node B are held at 1 while all other values of the heat vector (for all other nodes) are 0. The heat vector may be normalized or not. One or more diffusion equations may then be performed on the knowledge graph, by any appropriate method, such as those previously described in relation to FIG. 4A. The time evolution of the diffusion may be adjusted by any appropriate proportionality factor, such that for a first time (as depicted in FIG. 4D) greater than zero some heat has diffused from the first selected node(s) (e.g., chunk of information) but the heat of the nodes is still sufficiently non-equalized to allow for selection of one or more additional node or chunk of information for RAG.

FIG. 4D depicts a state of heating for the knowledge graph of FIG. 4C at a time greater than zero. As time is arbitrary, this time may be any appropriate time that allows for selection of additional nodes for inclusion in RAG, such as previously described in relation to FIG. 4B. As the heat applied on node A and node B in FIG. 4C diffuses, the connected nodes heat up, but may heat up relative to their relatedness (e.g., measure of similarity, betweenness centrality, etc.) to the hot node, such that nodes C and D heat up most quickly. Based on the state of the heat present in the knowledge graph, nodes C and D may be selected for inclusion in RAG, such as with the enhanced request 112 of FIG. 1. Nodes C and D may correspond to chunks of information (e.g., as described in the method depicted in FIG. 2) or entities which may correspond to one or more chunk of information (e.g., as described in the method depicted in FIG. 3). If the inclusion of nodes C and D in the enhanced request satisfies the knowledge window, diffusion may end and RAG may be performed with the enhanced request. If the inclusion of node B in the enhanced request does not satisfy the knowledge window (or other termination criterion), diffusion may continue, including by restarting with a new initial heat distribution including nodes C and D as hot nodes. As may be seen by comparing FIGS. 4B and 4D, different nodes may be selected for inclusion in the enhanced request based on whether the diffusion is a single time-evolution or is instead restarted with a different initial heat vector. Different methods of diffusion (e.g., continuous versus time series) may produce different results and may therefore be useful for different RAG applications.

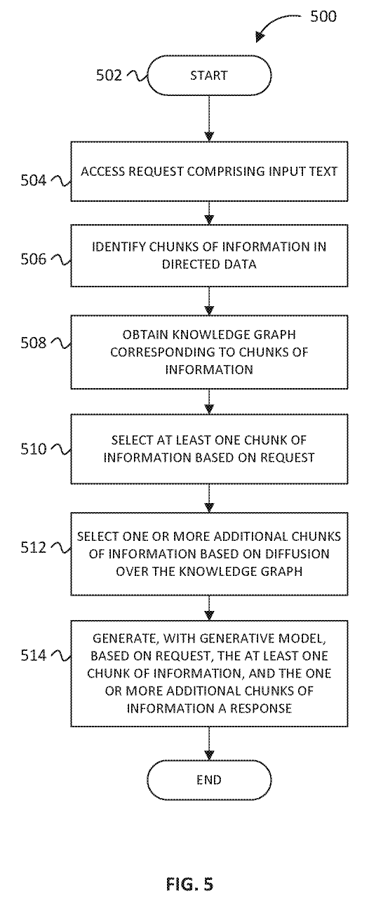

FIG. 5 is a flowchart illustrating a method 500 for diffusion-based RAG. FIG. 5 depicts example operations for a method 500. At block 502, in some embodiments, a system for diffusion-based RAG may be triggered. The system may be triggered by any appropriate method, such as those previously described in FIG. 1.

At block 504, in some embodiments, a request comprising input text is accessed. The request may be a query, prompt, or any other appropriate input or combination thereof. The request may be text string. The request may be a full sentence, a phrase, a sentence fragment, etc. The request may include one or more piece of directed data. The directed data may be identified concurrently with, prior to, after, etc. accessing of the request. The directed data may be identified in any appropriate manner, such as by tagging, pointing, uploading, etc.

At block 506, in some embodiments, chunks of information may be identified in the directed data. The chunks may be identified (e.g., extracted from) the directed data by any appropriate method, such as those previously described. In some embodiments, the identification of chunks or the chunks themselves may be stored with or identified in the directed data. In some embodiments, the chunks may be extracted, such as by a model, the directed data without having been previously stored with or identified in the directed data.

At block 508, a knowledge graph corresponding to the chunks of information is obtained. The knowledge graph may be obtained in any appropriate manner, such as by the method(s) described in reference to FIGS. 2 and 3. In some embodiments, the knowledge graph may be stored in or with the directed data and may be accessed concurrently with the directed data.

At block 510, in some embodiments, at least one chunk of information is selected based on the request. The at least one chunk of information may be a first chunk of information and may be obtained by any appropriate method, such as those previously described in relation to selection of the first chunk of information. The at least one chunk of information may be more than one chunk of information (e.g., first chunk(s) of information). The at least one chunk of information may correspond to a selected node of the knowledge graph.

At block 512, in some embodiments, one or more additional chunks of information may be selected based on diffusion over the knowledge graph. The diffusion may be described by any appropriate diffusion model. The one or more additional chunks of information may be selected based on diffusion from a first node or the knowledge graph to one or more additional nodes of the knowledge graph, such as previously described. The nodes may correspond to chunks of information or to entities (e.g., objects) which correspond to chunks of information. The diffusion may continue until a termination criterion is reached. In some embodiments, multiple different time-evolutions of diffusion may be used to select the one or more additional chunks of information.

At block 514, in some embodiments, a response to the request may be generated by a generative model based on the at least one chunk of information, the one or more additional chunks of information, and the request. The response may be generated by any appropriate manner, such as RAG. The generative model may be any appropriate generative mode, such as an LLM. The response may be output in any appropriate manner, such as in a list, in a paragraph, in textual format, etc. The response may be any appropriate response.

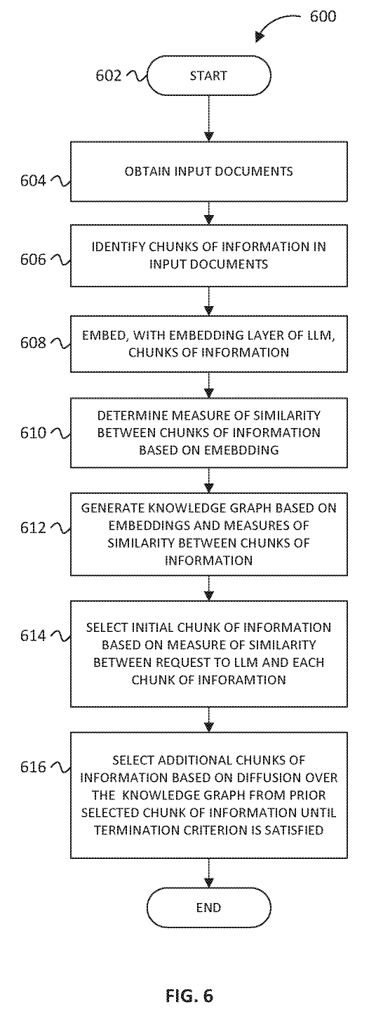

FIG. 6 is a flowchart illustrating a method 600 for diffusion-based RAG with embedding of directed data. At block 602, in some embodiments, a system for diffusion-based RAG with embedding may be triggered. The system may be triggered by any appropriate method, such as those previously described in FIG. 1.

At block 604, in some embodiments, one or more document is obtained. The documents may be any appropriate pieces of directed data, such as directed data 108 describe in relation to FIG. 1. The documents may be obtained by any appropriate manner, such as by uploading, from storage or memory, by directing to a location, etc.

At block 606, in some embodiments, chunks of information may be identified in the input documents. Chunks of information may be identified in any appropriate manner, such as those described in relation to block 506 of FIG. 5.

At block 608, in some embodiments, the chunks of information may be embedded (e.g., into a vector representation) with an embedding layer of an LLM. The embedding may occur in any appropriate manner, under any appropriate scheme. The vector representation may have any appropriate size, dimension, range, etc. In some embodiments, the vector representation may be Word 2Vec or another commonly used embedding. The LLM may be any appropriate generative model. The LLM may be the LLM with which RAG is to be performed.

At block 610, in some embodiments, measures of similarity may be determined between each of the chunks of information based on the embeddings. The measure of similarity may be a cosine similarity calculation or any other appropriate measure of similarity.

At block 612, in some embodiments, a knowledge graph may be generated based on the embeddings and the measures of similarity between the chunks of information. The knowledge graph may be generated in any appropriate manner and have any appropriate form, such as described in relation to FIG. 2. The knowledge graph may be stored with the input documents for later retrieval, including for subsequent RAG operations.

At block 614, in some embodiments, a first chunk of information is selected based on a measure of similarity between a request to the LLM and each of the chunks of information. The selection of the first chunk of information, which may correspond to selection of a first node of the knowledge graph, may be performed in any appropriate manner, such as by the method described in relation to FIG. 2.

At block 616, in some embodiments, additional chunks of information are selected based on diffusion over the knowledge graph based on previously selected chunk(s) of information, until a termination criterion is reached. The diffusion may be any appropriate diffusion. The diffusion may occur based on the edge values of the knowledge graph. The diffusion may occur in any appropriate manner, such as any one or more of the diffusion methods described in relation to FIGS. 4A-4D.

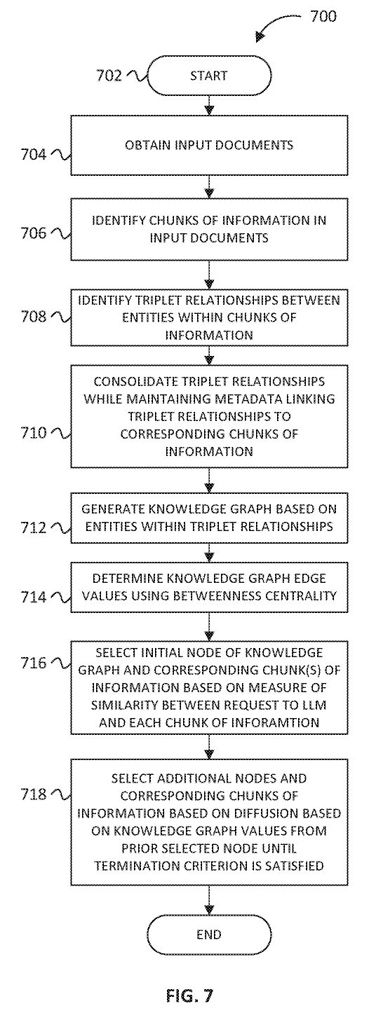

FIG. 7 is a flowchart illustrating a method 700 for diffusion-based RAG with entity and relationship triplet extraction from directed data. At block 702, in some embodiments, a system for diffusion-based RAG with relationship extraction may be triggered. The system may be triggered by any appropriate method, such as those previously described in FIG. 1.

At block 704, in some embodiments, one or more document is obtained. The documents may be obtained in any appropriate manner, such as by those methods described in relation to block 604 of FIG. 6.

At block 706, in some embodiments, chunks of information may be identified in the input documents. Chunks of information may be identified in any appropriate manner, such as those described in relation to block 506 of FIG. 5 or block 606 of FIG. 6.

At block 708, in some embodiments, triplet relationships between entities are identified within the chunks of information. The triplet relationships may be identified in any appropriate manner, such as by methods described in relation to FIG. 3. The triplet relationships may be identified in single stage or multi-stage operations. The triplet relationships may be identified by one or more model, such as an entity detection model, which may or may not be a generative model. The triplet relationships may be identified based on identified entities within the chunks of information. The triplet relationships may be pre-identified within the chunks of information and stored, including together with the input documents.

At block 710, in some embodiments, the triplet relationships may be consolidated and cleaned (e.g., reduced to unique triplet relationships) while maintaining metadata which links each of the triplet relationships to corresponding chunks of information. The data may be cleaned and consolidated in any appropriate manner. The metadata may be stored with each of the entities, with pairs of entities, with each of the triplet relationships, etc. The metadata may include information identifying chunks of information, document location, etc. in which each of the triplet relationships is found. The metadata may include any additional appropriate information.

At block 712, in some embodiments, a knowledge graph may be generated based on the entities within the triplet relationships. The knowledge graph may be generated in any appropriate manner and have any appropriate form, such as described in relation to FIG. 3. The entities of the triplet relationship may correspond to the nodes of the knowledge graph, while the relationships between entities may correspond to the edges of the knowledge graph. The knowledge graph may be stored with the input documents for later retrieval, including for subsequent RAG operations.

At block 714, in some embodiments, edge values for the knowledge graph may be determined, such as by betweenness centrality. In some embodiments, edge values may be determined by any other appropriate method. The edge values may be determined by betweenness centrality as described in relation to FIG. 3.

At block 716, in some embodiments, a fist node of the knowledge graph and a corresponding first chunk of information is selected based on a measure of similarity between a request to the LLM and each of the chunks of information. The selection of the node, which may correspond to selection of a first chunk of information, may be performed in any appropriate manner, such as by the method described in relation to FIG. 3.

At block 718, in some embodiments, additional nodes of the knowledge graph and corresponding chunks of information are selected based on diffusion over the knowledge graph based on previously selected node(s) and corresponding chunk(s) of information, until a termination criterion is reached. The diffusion may be any appropriate diffusion. The diffusion may occur based on the edge values of the knowledge graph. The diffusion may occur in any appropriate manner, such as any one or more of the diffusion methods described in relation to FIGS. 4A-4D.

In the flowcharts described above, block ordering is illustrative only, and various operations may occur in different orders, concurrently, etc. Likewise, operations may occur in different places, such as by different models, at stored data, at the model storage location, etc.

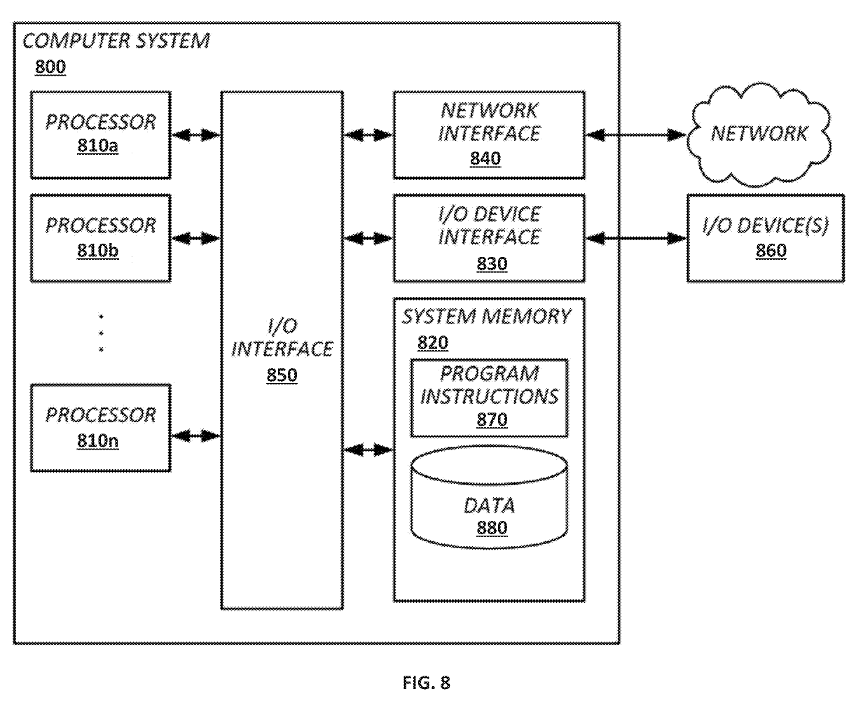

FIG. 8 is a schematic of a computing system, in accordance with some embodiments of the present disclosure. FIG. 8 is a diagram that illustrates an exemplary computing system 800 in accordance with embodiments of the present disclosure. Various portions of systems and methods described herein may include or be executed on one or more computing systems similar to computing system 800. Further, processes and modules described herein may be executed by one or more processing systems similar to that of computing system 800.

Computing system 800 may include one or more processors (e.g., processors 810a-810n) coupled to system memory 820, an input/output I/O device interface 830, and a network interface 840 via an input/output (I/O) interface 850. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 800. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 820). Computing system 800 may be a uni-processor system including one processor (e.g., processor 810a), or a multi-processor system including any number of suitable processors (e.g., 810a-810n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 800 may include a plurality of computing devices (e.g., distributed computing systems) to implement various processing functions.

I/O device interface 830 may provide an interface for connection of one or more I/O devices 860 to computing system 800. I/O devices may include devices that receive input (e.g., from a user) or output information (e.g., to a user). I/O devices 860 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 860 may be connected to computing system 800 through a wired or wireless connection. I/O devices 860 may be connected to computing system 800 from a remote location. I/O devices 860 located on remote computing system, for example, may be connected to computing system 800 via a network and network interface 840.

Network interface 840 may include a network adapter that provides for connection of computing system 800 to a network. Network interface 840 may facilitate data exchange between computing system 800 and other devices connected to the network. Network interface 840 may support wired or wireless communication. The network may include an electronic communication network, such as the Internet, a local area network (LAN), a wide area network (WAN), a cellular communications network, or the like.

System memory 820 may be configured to store program instructions 870 or data 880. Program instructions 870 may be executable by a processor (e.g., one or more of processors 810a-810n) to implement one or more embodiments of the present techniques. Instructions 870 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 820 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 820 may include a non-transitory computer readable storage medium that may have program instructions stored thereon that are executable by a computer processor (e.g., one or more of processors 810a-810n) to cause the subject matter and the functional operations described herein. A memory (e.g., system memory 820) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 850 may be configured to coordinate I/O traffic between processors 810a-810n, system memory 820, network interface 840, I/O devices 860, and/or other peripheral devices. I/O interface 850 may perform protocol, timing, or other data transformations to convert data signals from one component (e.g., system memory 820) into a format suitable for use by another component (e.g., processors 810a-810n). I/O interface 850 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 800 or multiple computing systems 800 configured to host different portions or instances of embodiments. Multiple computing systems 800 may provide for parallel or sequential processing/execution of one or more portions of the techniques described herein.

Those skilled in the art will appreciate that computing system 800 is merely illustrative and is not intended to limit the scope of the techniques described herein. Computing system 800 may include any combination of devices or software that may perform or otherwise provide for the performance of the techniques described herein. For example, computing system 800 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 800 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 800 may be transmitted to computing system 800 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 800 may be transmitted to computing system 800 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, notwithstanding use of the singular term "medium," the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, the applicant has grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or "a element" includes a combination of two or more elements, notwithstanding use of other terms and phrases for one or more elements, such as “one or more.” The term "or" is, unless indicated otherwise, non-exclusive, i.e., encompassing both "and" and "or." Terms describing conditional relationships, e.g., "in response to X, Y," "upon X, Y,", “if X, Y,” "when X, Y," and the like, encompass causal relationships in which the antecedent is a necessary causal condition, the antecedent is a sufficient causal condition, or the antecedent is a contributory causal condition of the consequent, e.g., "state X occurs upon condition Y obtaining" is generic to "X occurs solely upon Y" and "X occurs upon Y and Z." Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computing system” performing step A and “the computing system” performing step B may include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X’ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like "parallel," "perpendicular/orthogonal," “square”, “cylindrical,” and the like, should be construed as encompassing items that substantially embody the properties of the geometric construct, e.g., reference to "parallel" surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms "first", "second", "third," “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

Grouped, numerated embodiments are listed below by way of example. Reference to prior characterizations of embodiments within are within each group.

### Embodiments

Clause 1. A system, comprising: a processor programmed to: access a request comprising input text to search one or more documents; identify chunks of textual information based on the one or more documents; generate a knowledge graph based on the chunks of textual information; select, from the chunks of textual information, at least one chunk of textual information based on the input text; select, from the chunks of textual information, one or more additional chunks of textual information for retrieval-augmented generation (RAG) in a large language model (LLM), based on diffusion over the knowledge graph from the at least one chunk of textual information; and generate a response to the request comprising the input text, by the LLM using RAG based on the selected at least one chunk of textual information, the selected one or more additional chunks of textual information.

Clause 2. The system of clause 1, wherein to select the at least one chunk of textual information, the processor is programmed to select the at least one chunk of textual information based on a strength of a first contextual relationship.

Clause 3. The system of clause 2, wherein the first contextual relationship is determined based on the input text and each of the chunks of textual information.

Clause 4. The system of clause 1, wherein to select the one or more additional chunks of textual information, the processor is programmed to: select the one or more additional chunks of textual information for RAG based on diffusion applied over the knowledge graph, wherein strength of diffusion along edges of the knowledge graph is based on strength of second contextual relationships, the second contextual relationships being determined between each of the chunks of textual information.

Clause 5. The system of clause 4, wherein the second contextual relationships between the chunks of textual information are generated by embedding the chunks of textual information and wherein strength of the contextual relationships between the chunks is determined based on similarity of the embeddings.

Clause 6. The system of clause 5, wherein the knowledge graph is generated based on the strength of the contextual relationship based on the embeddings.

Clause 7. The system of clause 4, wherein the one or more additional chunks of textual information are selected based on the diffusion applied over the knowledge graph until a termination criterion is satisfied.

Clause 8. The system of clause 7, wherein the termination criterion is defined by one or more of the following: a size of a knowledge window, a number of one or more additional chunks of textual information selected, a number of iterations, a distance traveled along the knowledge graph, or a combination thereof.

Clause 9. The system of clause 7, wherein the one or more additional chunks of textual information are selected based on a cumulative diffusion along the knowledge graph.

Clause 10. The system of clause 7, wherein the one or more additional chunks of textual information are selected based on an additional diffusion from the at least one chunk of textual information and previously selected one or more additional chunks along the knowledge graph.

Clause 11. The system of clause 1, wherein the diffusion is a Laplacian diffusion.

Clause 12. The system of clause 11, wherein, at the start of diffusion, elements of a heat vector corresponding to the at least one chunk of textual information are one, while substantially all other elements of the heat vector are zero.

Clause 13. The system of clause 11, wherein at the start of diffusion, elements of a heat vector corresponding to the at least one chunk of textual information and any previously selected one or more additional chunks of textual information are one, while substantially all other elements of the heat vector are zero.

Clause 14. The system of clause 5, wherein the embedding of the chunks of textual information is performed by substantially the same method as the embedding of the LLM.

Clause 15. The system of clause 1, wherein the knowledge graph is one or more substantially fully connected knowledge graphs.

Clause 16. The system of clause 1, wherein to generate the knowledge graph, the processor is programmed to: identify triplet relationships between entities contained within the chunks.

Clause 17. The system of clause 16, wherein the triplet relationships are identified based on entities and relationships between said entities extracted from within the chunks, and wherein the triplet relationships are further identified as corresponding to the chunks from which they are extracted.

Clause 18. The system of clause 17, the processor further programmed to perform data cleaning to consolidate duplicate triplet relationships while maintaining metadata identifying each of multiple chunks from which the duplicate triplet relationships are extracted.

Clause 19. The system of clause 16, wherein the knowledge graph is generated based on the triplet relationships, wherein the entities correspond to nodes on the knowledge graph and wherein the relationships between the entities correspond to edges of the knowledge graph.

Clause 20. The system of clause 16, wherein a strength of the relationship between the entities of the triplet relationships or one or more edge weights are determined, based on at least one of the following: path length, number of paths, path duplication, betweenness centrality, document location, or a combination thereof.

Clause 21. The system of clause 20, wherein to select the one or more additional chunks of textual information, the processor is programmed to: select the one or more additional chunks of textual information for RAG based on diffusion applied over the knowledge graph, wherein the strength of diffusion along edges of the knowledge graph is based on the one or more edge weights.

Clause 22. The system of clause 16, wherein to select the at least one chunk of textual information, the processor is programmed to select the at least one chunk of textual information based on a strength of a first contextual relationship, wherein the first contextual relationship is determined based on a similarity between the input text and each of the triplet relationships or entities of the triplet relationship.

Clause 23. The system of clause 16, wherein a strength of one or more edge weights of the knowledge graph are determined based on (1) at least one of the following: path length, number of paths, path duplication, betweenness centrality, document location, or a combination thereof and based on (2) strength of contextual relationships between each of the chunks of textual information.

Clause 24. The system of clause 23, wherein the contextual relationships between the chunks of textual information are generated by embedding the chunks of textual information and wherein strength of the contextual relationships between the chunks is determined based on similarity of the embeddings.

Clause 25. A non-transitory computer-readable medium storing instructions that, when executed by a processor, programs the processor to: access one or more knowledge graph generated for one or more documents; determine, based on a request comprising input text, a first one or more nodes from the knowledge graph for retrieval-augmented generation (RAG) with a large language model (LLM); select, based on diffusion along the one or more knowledge graph, one or more additional nodes for inclusion in the RAG with the LLM; and generate, based on the first one or more nodes and the selected one or more additional nodes and the LLM, a response to the request.

Clause 26. The medium of clause 25, the processor further programmed to: generate, based on the one or more documents, one or more knowledge graph; and store the one or more knowledge graphs together with the documents.

Clause 27. The medium of clause 25, wherein the processor programmed to: determine the first one or more nodes based on a similarity between the request and each of the one or more nodes.

Clause 28. A method for retrieval-augmented generation (RAG) with a large language model (LLM) comprising: receiving a request comprising input text for the LLM and one or more pieces of input data associated with the request; accessing, for the one or more pieces of input data, one or more knowledge graphs identifying relationships between chunks within the input data, wherein nodes of the one or more knowledge graphs correspond to chunks within the input data; selecting, from the one or more knowledge graphs, at least one node based on the request; selecting, based on diffusion from the at least one node, one or more additional nodes of the knowledge graph; and generating a response to the request, by the LLM using RAG, based on the request and the chunks of the input data corresponding to the at least one node and the selected one or more additional nodes.

Clause 29. The method of clause 28, further comprising: generating, for each of the one or more pieces of input data, the one or more knowledge graphs identifying the relationships between the chunks of the input data.

Clause 30. The method of clause 29, wherein generating the one or more knowledge graphs comprises: dividing the one or more pieces of input data into the chunks; embedding the chunks of input data by an embedding method of the LLM; determining a similarity measure between each of the chunks of input data; and generating the one or more knowledge graphs based on the similarity measures between each of the chunks of input data, wherein the similarity measures comprise values for connections between the nodes, and wherein the diffusion occurs between the nodes along the connections based on their values.

Clause 31. The method of clause 30, wherein selecting comprises: selecting the at least one node based on a similarity measure between the request and each of the nodes; and selecting the one or more additional nodes based on diffusion from the at least one node based on the values for connections between the nodes.

Clause 32. The method of clause 29, wherein generating the one or more knowledge graphs comprises: dividing the one or more pieces of input data into the chunks; identifying, based on entities contained within the chunks of input data, data triplets, each data triplet relating at least two entities by a relationship; and generating the one or more knowledge graph based on the entities of the data triplets, wherein the entities comprise the nodes of the one or more knowledge graph, and wherein the relationships comprise edges of the one or more knowledge graphs, and wherein each data triplet is identified as corresponding to at least one or the chunks of input data.

Clause 33. The method of clause 32, wherein values for the edges of the knowledge graph are determined by at least one of the following: path length, number of paths, path duplication, betweenness centrality, document position, or a combination thereof.

Clause 34. The method of clause 32, wherein selecting comprises: selecting the at least one node based on a similarity measure between the request and each of the chunks of input data; and selecting the one or more additional nodes based on diffusion from the at least one node based on values for the edges of the knowledge graph.

Clause 35. The method of clause 34, wherein generating an output related to the request comprises: determining the chunks of input data corresponding to the at least one node and the selected one or more additional nodes; and generating, based on the LLM and the chunks of the input data, the response to the request.

It should be understood that the present invention is not limited to the above-described techniques, features or aspects. Instead, the specific details described above are disclosed as example forms of implementing the claims, as set forth below.

What is claimed is:

1. A system, comprising:
a processor programmed to:
access a request comprising input text to search one or more documents;
identify chunks of textual information based on the one or more documents;
generate a knowledge graph based on the chunks of textual information;
select, from the chunks of textual information, at least one chunk of textual information based on the input text;
select, from the chunks of textual information, one or more additional chunks of textual information for retrieval-augmented generation (RAG) in a large language model (LLM), based on diffusion over the knowledge graph from the at least one chunk of textual information; and
generate a response to the request comprising the input text, by the LLM using RAG based on the selected at least one chunk of textual information, the selected one or more additional chunks of textual information.

2. The system of claim 1, wherein to select the at least one chunk of textual information, the processor is programmed to select the at least one chunk of textual information based on a strength of a first contextual relationship.

3. The system of claim 1, wherein to select the one or more additional chunks of textual information, the processor is programmed to:
select the one or more additional chunks of textual information for RAG based on diffusion applied over the knowledge graph, wherein strength of diffusion along edges of the knowledge graph is based on strength of second contextual relationships, the second contextual relationships being determined between each of the chunks of textual information.

4. The system of claim 3, wherein the one or more additional chunks of textual information are selected based on the diffusion applied over the knowledge graph until a termination criterion is satisfied and wherein the termination criterion is defined by one or more of the following: a size of a knowledge window, a number of one or more additional chunks of textual information selected, a number of iterations, a distance traveled along the knowledge graph, or a combination thereof.

5. The system of claim 4, wherein the one or more additional chunks of textual information are selected based on a cumulative diffusion along the knowledge graph.

6. The system of claim 4, wherein the one or more additional chunks of textual information are selected based on an additional diffusion from the at least one chunk of textual information and previously selected one or more additional chunks along the knowledge graph.

7. The system of claim 1, wherein the diffusion is a Laplacian diffusion and wherein, at a start of diffusion, elements of a heat vector corresponding to the at least one chunk of textual information are one, while substantially all other elements of the heat vector are zero.

8. The system of claim 1, wherein the diffusion is a Laplacian diffusion and wherein at a start of diffusion, elements of a heat vector corresponding to the at least one chunk of textual information and any previously selected one or more additional chunks of textual information are one, while substantially all other elements of the heat vector are zero.

9. The system of claim 1, wherein to generate the knowledge graph, the processor is programmed to:
identify triplet relationships between entities contained within the chunks,
wherein the triplet relationships are identified based on entities and relationships between said entities extracted from within the chunks, and wherein the triplet relationships are further identified as corresponding to the chunks from which they are extracted.

10. The system of claim 9, wherein the knowledge graph is generated based on the triplet relationships, wherein the entities correspond to nodes on the knowledge graph and wherein the relationships between the entities correspond to edges of the knowledge graph and wherein a strength of the relationship between the entities of the triplet relationships or one or more edge weights are determined, based on at least one of the following: path length, number of paths, path duplication, betweenness centrality, document location, or a combination thereof.

11. The system of claim 10, wherein to select the one or more additional chunks of textual information, the processor is programmed to:
select the one or more additional chunks of textual information for RAG based on diffusion applied over the knowledge graph, wherein the strength of diffusion along edges of the knowledge graph is based on the one or more edge weights.

12. The system of claim 9, wherein a strength of one or more edge weights of the knowledge graph are determined based on (1) at least one of the following: path length, number of paths, path duplication, betweenness centrality, document location, or a combination thereof and based on (2) strength of contextual relationships between each of the chunks of textual information, wherein the contextual relationships between the chunks of textual information are generated by embedding the chunks of textual information and wherein strength of the contextual relationships between the chunks is determined based on similarity of the embeddings.

13. A non-transitory computer-readable medium storing instructions that, when executed by a processor, programs the processor to:
access one or more knowledge graph generated for one or more documents;
determine, based on a request comprising input text, a first one or more nodes from the knowledge graph for retrieval-augmented generation (RAG) with a large language model (LLM);
select, based on diffusion along the one or more knowledge graph, one or more additional nodes for inclusion in the RAG with the LLM; and
generate, based on the first one or more nodes and the selected one or more additional nodes and the LLM, a response to the request.

14. The medium of claim 13, the processor further programmed to:
determine the first one or more nodes based on a similarity between the request and each of the one or more nodes.

15. A method for retrieval-augmented generation (RAG) with a large language model (LLM) comprising:
receiving a request comprising input text for the LLM and one or more pieces of input data associated with the request;
accessing, for the one or more pieces of input data, one or more knowledge graphs identifying relationships between chunks within the input data, wherein nodes of the one or more knowledge graphs correspond to chunks within the input data;
selecting, from the one or more knowledge graphs, at least one node based on the request;
selecting, based on diffusion from the at least one node, one or more additional nodes of the knowledge graph; and
generating a response to the request, by the LLM using RAG, based on the request and the chunks of the input data corresponding to the at least one node and the selected one or more additional nodes.

16. The method of claim 15, further comprising:
generating, for each of the one or more pieces of input data, the one or more knowledge graphs identifying the relationships between the chunks of the input data,
wherein generating the one or more knowledge graphs comprises:
dividing the one or more pieces of input data into the chunks;
embedding the chunks of input data by an embedding method of the LLM;
determining a similarity measure between each of the chunks of input data; and
generating the one or more knowledge graphs based on the similarity measures between each of the chunks of input data,
wherein the similarity measures comprise values for connections between the nodes, and wherein the diffusion occurs between the nodes along the connections based on their values.

17. The method of claim 16, wherein selecting comprises:
selecting the at least one node based on a similarity measure between the request and each of the nodes; and
selecting the one or more additional nodes based on diffusion from the at least one node based on the values for connections between the nodes.

18. The method of claim 15, further comprising:
generating, for each of the one or more pieces of input data, the one or more knowledge graphs identifying the relationships between the chunks of the input data,,
wherein generating the one or more knowledge graphs comprises:
dividing the one or more pieces of input data into the chunks;
identifying, based on entities contained within the chunks of input data, data triplets, each data triplet relating at least two entities by a relationship; and
generating the one or more knowledge graph based on the entities of the data triplets, wherein the entities comprise the nodes of the one or more knowledge graph, and wherein the relationships comprise edges of the one or more knowledge graphs, and wherein each data triplet is identified as corresponding to at least one or the chunks of input data.

19. The method of claim 18, wherein values for the edges of the knowledge graph are determined by at least one of the following: path length, number of paths, path duplication, betweenness centrality, document position, or a combination thereof.

20. The method of claim 18, wherein selecting comprises:
selecting the at least one node based on a similarity measure between the request and each of the chunks of input data; and
selecting the one or more additional nodes based on diffusion from the at least one node based on values for the edges of the knowledge graph.
